(19) United States
(12) Patent Application Publication
(10) Pub. No.: US 2005/0238803 A1
(43) Pub. Date: Oct. 27, 2005

(54) Method for adhering getter material to a surface for use in electronic devices

(76) Inventors: James Daniel Tremel, Santa Barbara, CA (US); Matthew Dewey Hubert, Goleta, CA (US); Terri Cardellino, Santa Barbara, CA (US); Yong Cho, Seoul (KR)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/984,451

(22) Filed: Nov. 9, 2004

Related U.S. Application Data
(60) Provisional application No. 60/519,139, filed on Nov. 12, 2003.

(51) Int. Cl. B05D 5/12; B05D 3/12; B32B 9/00

(52) U.S. Cl. 427/180; 427/355; 427/372.2; 428/446; 428/702

(57) ABSTRACT

Disclosed is a method of adhering a getter material to a surface, wherein the getter is used to remove and control contaminant gases in the environment surrounding the active layers in an electronic device. The getter material is applied from a getter composition comprising getter particles, inorganic binders and a liquid medium to create a composition of a consistency that can be deposited on the surface in any pattern and in any thickness desired. The surface on which the getter composition is deposited can be heated separately from the electronic device so as to activate the getter material and cause the particles to adhere to the surface without the need of additional adhesive layers or other materials.

### FIELD OF THE INVENTION

This invention relates to a method for adhering a getter composition to at least a portion of a surface, wherein the getter is used to remove and control contaminant gases in the environment surrounding the active materials of a electronic device sealed within an enclosure.

### BACKGROUND INFORMATION

Electronic organic devices are sensitive to and have decreased performance when critical components are exposed to undesirable contaminants, including moisture and other contaminant gases, such as oxygen, hydrogen, and organic gases. For example, the relatively low work function metals, such as barium or calcium, are often used as the cathode material in electronic organic devices for device performance reasons. Unfortunately, low work function metals such as calcium, barium and strontium typically react with oxygen and form water vapor. These reactions destroy their required low work function property.

Another example of the destructive nature of contaminants in organic electronic devices occurs in organic light-emitting diode displays (OLEDs). OLEDs are fabricated using thin films of luminescent organic molecules as the active layers, which layers must be protected from degradation by moisture and other contaminant gases.

Current techniques for protecting organic electronic devices from such degradation include applying an environmental barrier coat to the outside of the organic electronic device, putting an absorbent or adsorbent getter material on the edges of the device where contaminants enter into the interior of the organic electronic device or within an enclosure containing the organic electronic device to enclose the materials most sensitive to contaminant gases with the getter material.

Yet all known materials and known ways of using “gettering” materials do not provide sufficient long term “gettering” for the life time of certain electronic organic devices. In addition, known methods result in a getter that must be adhered to a surface in the interior of the device with an adhesive, which can generate contaminant gases within the device over time. Also, known methods can result in a thick gettering layer that increases the bulk of the device, is inflexible in process requirements, and tends to leave loose particles within the device enclosure.

Manufacture of organic electronic devices presents certain process limitations to the use of getters. Absorbent getters are inherently moisture sensitive and the absorption reaction is not reversible, requiring manufacture in a low moisture environment. Adsorbent getters, on the other hand, commonly contain zeolites and other molecular sieve materials that must be heated for activation at temperatures up to about 650° C. and sealed within a device in a controlled atmosphere. However the active organic materials in organic electronic devices will not withstand temperatures much above about 300° C., requiring that the remaining materials in the device, to be useful, will need to be applied and heat treated in a manner that does not interfere with the over all manufacturing requirements of the device.

In addition, traditional getter materials are hard to form into the variety of shapes and sizes needed to accommodate the wide variety of designs for organic electronic devices and require expensive tooling equipment for manufacture.

One strategy for overcoming some of these difficulties has been development of “lid” getter technology wherein the getter material is formed in a well in a lid that is incorporated after manufacture into an enclosure for the OLED to create an hermetically sealed environment or package for the device. However, these lid getters tend to add undesirable bulk to the finished device.

Thus, there remains a need for a getter that can perform in an organic electronic device over the expected life-time of the device, but that also is adaptable to various modes of application, does not add bulk and extra components, permits flexibility in the design (shape, size, materials) of the organic electronic device, and simplifies the manufacturing of such devices.

### SUMMARY OF THE INVENTION

This inventions relates to a method of adhering a getter material to a surface, wherein the getter is used to remove and control contaminant gases in the environment surrounding the active layers in an electronic device. The getter material is applied from a getter composition comprising getter particles, inorganic binders and a liquid medium to create a composition of a consistency that can be deposited on the surface in any pattern and in any thickness desired. The surface to which the getter composition is deposited can be heated separately from the electronic device so as to activate the getter material and cause the particles to adhere to the surface without the need of additional adhesive layers or other materials. In one embodiment of the present invention, the surface is part of is a sealing apparatus used to enclose the electronic device.

In one embodiment, methods are provided for adhering a getter material to at least a portion of a surface including applying the a getter composition containing particles of getter and inorganic binder in a liquid medium to a surface and densifying the getter composition so as to activate the getter material and cause it to adhere to the surface. And in yet another embodiment, an electronic device is provided that includes at least one layer of getter made according to the present method disclosed herein.

In one embodiment, methods are provided for sealing an electronic device on a substrate with a sealing structure, said method comprising:
(a) applying to at least a portion of a surface of a lid at least one getter composition comprising:
   (i) particles of at least one getter;
   (ii) particles of at least one inorganic binder; and
   (iii) a liquid medium, and
(b) densifying the getter composition in a environment substantially free of contaminants so as to activate the getter material and to cause it to adhere to the surface, to form the activated sealing structure;
(c) adhering the activated sealing structure to the substrate so as to enclose the electronic device; with the proviso that at least one of the following conditions is met:
(1) the activated sealing structure is at a temperature greater than 50° C. in step (c);
(2) the activated sealing structure is kept under a vacuum of less than 10⁻⁴ torr between step (b) and step (c);
(3) the time elapsed between step (b) and step (c) is less than 120 minutes.

Other features and advantages of the invention will be apparent from the following detailed description, and from the claims.

### BRIEF DESCRIPTION OF THE DRAWINGS

FIG. 1 is a drawing showing in cross-section a representative organic electronic device having a getter prepared according to the methods described herein. FIG. 2 is a drawing showing in cross-section an organic electronic device having an enclosure made according to the methods described herein. FIG. 3 is a drawing showing in cross-section an organic electronic device within an enclosure made according to the methods described herein.

FIG. 4 is a drawing showing one pattern of a first getter composition in accordance with one embodiment of the present invention.

FIG. 5 is a drawing showing a second pattern of one getter composition and a second glass frit composition in accordance with one embodiment of the present invention.

FIG. 6 is a drawing showing a pattern of at least two getter compositions and a second glass frit composition in accordance with one embodiment of the present invention.

FIG. 7 is a drawing showing a pattern of getter composition, glass frit composition and adhesive in accordance with one embodiment of the present invention.

FIG. 8 is a drawing showing two patterns of deposited getter compositions in accordance with one embodiment of the present invention.

FIG. 9 is a drawing showing two patterns of deposited getter compositions and a pattern of glass frit composition in accordance with one embodiment of the present invention.

### DETAILED DESCRIPTION

It has been discovered that the present methods for adhering an adsorbent getter material to a surface can be used to eliminate undesirable design features, such as a well in which to place the getter, as used in prior art “lid” technology. Moreover, when applied to the surface as a getter composition and then solidified thereon, the getter can be densified (colloquially, activated or “fired in place”) at any time prior to sealing the electronic device of interest. A mode of applying the getter composition to the surface can be used wherein its consistency can range from as thick as a paste to as fluid as ink. Moreover, getter structures can be created on the surface in any desired shape or thickness by applying one or more additional separate or overlapping applications of the of one or more getter composition.

The getter composition of the present invention comprises particles of a getter and an inorganic binder, and a liquid medium. The getter composition, is applied directly to the surface and densified thereon. The great flexibility in choice of consistency for the getter composition allows application of the getter materials to the surface by a variety of known techniques, with more fluid mixtures providing a thinner layer of getter and paste-like getter compositions providing a thicker getter layer.

The inorganic binder permits a low densification temperature of about 400° C. to about 650° C. and good adhesion between the heat-treated getter and surface. Firing temperature is limited by the choice of surface material (e.g., glass, metal, ceramic) because the getter is densified on the surface to which it is applied, causing self adherence to the surface. For example, firing temperature needs to be below 650° C. if a typical glass surface based on soda lime silicates is selected. Firing above 650° C. with the getter on a glass surface may induce warping or distortion of the glass surface. In case of a surface with a higher melting temperature, such as metal-based surface, a temperature above 650° C. may be used for densification of the getter.

Thus, adhesion between the getter and surface is improved by selection of a low softening inorganic binder, such as clay particles and/or glass frit. A low softening inorganic binder, such as glass frit and clay binder can help relieve interfacial stress by penetration into voids in the substrate via viscous flow during firing. Mechanical locking is likely to be the dominant mechanism for adhesion between getter and substrate.

The process conditions employed and getter structures formed are compatible with incorporation of the surface into an enclosure for hermetically sealing an OLED so as to protect the organic layers therein from moisture and other contaminant gases released from materials within the device as well as from those in the environment.

The electronic devices created using the method of the present invention can have contaminant gases within a sealed enclosure maintained to levels below about 1000 ppm in one embodiment. In another embodiment, the contaminant gases within the enclosed environment of the electronic device is less than 100 ppm.

For purposes of understanding the invention, the following terms used herein have the following meanings.

As used herein, the term “adsorbent” and “adsorbing” refer to a solid material that has the ability to cause molecules of gases or vapors to condense on its surface and be gettered without changing the adsorbent physically or chemically.

As used herein, the term “clay” means a mineral particle composition having a diameter less than 1/256 mm (4 microns) and composed of a loosely defined group of hydrous silicate minerals, essentially of aluminum.

As used herein, the term “densifying” or “densification”, as used with respect to the getter composition containing the getter, inorganic binder and liquid medium, means heating or reheating the molecular sieve so as to drive off substantially all volatiles, including, but not limited to the liquid medium used in getter composition and moisture of the getter, thus “activating” the getter. The densified getter, when exposed to environmental conditions (including the environment of a sealed electronic device), will adsorb contaminant gases and will need to be “reactivated” by reheating the getter to drive of contaminant gases.

Densifying further means heating the getter materials sufficiently to cause self-adherence of the getter material, particularly the inorganic binder therein, to the surface to which it has been applied. Densifying, may be accomplished in one continuous act during which process conditions may be adjusted to accomplish the densification of the getter, i.e., bringing the getter composition from the fluid or paste state to a dried or more solid state, and then further heating the solid getter material on the surface to the densified state. This can be done in one continuous act. Alternatively, when heat treatment is separated into two or more acts, densifying means the heat treatment that brings a “solidified” getter from the “solidified” state, as described herein, to the densified state and in condition to adsorb containment gases.

The getter composition comprising the getter, inorganic binder and liquid medium is mixed together to create either a composition that can be a dispersion, suspension or emulsion. The actual physical condition of the getter composition will vary depending the selection of molecule sieve particles, inorganic binder particles and the liquid media used. Since various combination of any of this can be used the consistency of the getter composition

As used herein, the term “organic electronic device” means a device including one or more semiconductor layers or materials. Organic electronic devices include: (1) devices that convert electrical energy into radiation (e.g., a light-emitting diode, light emitting diode display, or diode laser), (2) devices that detect signals through electronics processes (e.g., photodetectors (e.g., photoconductive cells, photoresistors, photoswitches, phototransistors, phototubes), IR detectors), (3) devices that convert radiation into electrical energy (e.g., a photovoltaic device or solar cell), and (4) devices that include one or more electronic components that include one or more organic semi-conductor layers (e.g., a transistor or diode).

As used herein, the term “gas” means a phase of matter that expands indefinitely to fill a containment vessel that is characterized by a low density. The phrase “contaminant gases” as used herein, includes moisture, oxygen, hydrogen, hydrocarbon vapors, and all manner of gases that may be in the atmosphere or generated internally in an organic electric device.

As used herein, the term “getter” or “gettering” means a substance that adsorbs or the act of adsorbing contaminant gases that cause damage to organic layers in electronic devices. The getter materials may also contain a minor proportion of materials that absorb water. For example, certain clays and glass frits that are useful as the inorganic binder in the getters made according to the present methods will absorb water. In one embodiment, the getter comprises a molecular sieve.

As used herein, the term “hermetically” means a substantially complete seal against the escape or entry of air.

As used herein, the term “molecular sieve” means a crystalline, porous, molecular structure that selectively adsorbs or rejects molecules based on differences in molecular size or shape. The molecular sieve particles suitable for the present invention include alkaline metal oxides, alkaline earth metal oxides, sulfates, metal halides, and perchlorates and mixtures thereof. In one embodiment, the molecular sieve is a zeolite.

The size of the particles of getter and inorganic binder will vary depending upon the consistency and type of getter composition desired as is suitable for the mode of application and the nature of the surface to which it is applied. In one embodiment, the getter is a molecular sieve. The particle size of the molecular sieve and inorganic binder can be from 0.1 to 200 microns. In one embodiment, the particle size of a substantial number of the particles is less than 20 microns. In one embodiment the particle size of a substantial number of the particles is less than 10 microns. In one embodiment, a substantial portion of the particles have a size from about 0.1 to 10 microns. In another embodiment, a substantial portion of the particles have a size in the range of from 2-6 microns. In another embodiment, the particles have a size of from 3-5 microns.

For example, a liquid dispersion having the consistency of a paste is particularly suitable for applying the getter composition by screen-printing and for this embodiment the particles can be powder-sized provided that the particles are not so fine that a too thick paste is created such that it can not be transfer to the selected portion of the surface that is to receive the getter composition.

In one embodiment, the molecular sieve is a zeolite, either naturally occurring or synthetic. Well known zeolites include chabazite (also referred to as zeolite D), clinoptilolite, erionite, faujasite (also referred to as zeolite X and zeolite Y), ferrierite, mordenite, zeolite A, and zeolite P. Detailed descriptions of the above-identified zeolites, as well as others, may be found in D. W. Breck, Zeolite Molecular Sieves, John Wiley and Sons, Present York, 1974, hereby incorporated by reference. For example, type 3A, 4A and 13X zeolites all have the ability to adsorb water molecules and are presently preferred as the adsorbent molecular sieve for making the present moisture getters. Such zeolites comprise Na₂O, Al₂O₃ and SiO₂.

Certain adsorbent getters can adsorb gaseous contaminants in addition to moisture, such as gaseous H₂ and O₂. An example of a commercially available, solid getter tablet based on zeolite technology that can be made to adsorb contaminant gases, as well as moisture is described in European Patent Application No. WO 02/430098 A1 by Synetix.

Non-limiting examples of clays that are suitable as the inorganic binder in an aqueous dispersion for making a layer of getter material adhered to a surface include attapulgite, kaolin, sepiolite, palygorskite, kaolinite, plastic ball clays, clays of the attapulgite or kaolin types, bentonite, montmorillonite, illite, chlorite, bentonite-type clay, some of which also absorb moisture, and mixtures thereof. Magnesium aluminosilicate clays are presently preferred.

For example, a moisture getter can be formed from particles of a wafer that is commercially available under the trade name TRI-SORB® (Sud-Chemie, Belen, N.Mex.). TRI-SORB® is available as a compressed tablet comprising pre-calcined particles of an A4 zeolite in a binder matrix of magnesium aluminosilicate clay. The A4 zeolite in TRI-SORB® consists of aluminum and silicon oxides in approximately equal amounts with sodium as the counter ion. The tablets are ground to form finely divided particles comprising a zeolite in a matrix of clay.

Additional examples of inorganic binders that can be used in the present methods are glass frits. Non-limiting examples of glass frits that are suitable for inclusion in the inorganic binder in the present methods include those that comprise at least one of PbO, Al₂O₃, SiO₂, B₂O₃, ZnO, Bi₂O₃, Na₂O, Li₂O, P₂O₅, NaF and CdO, and MO where O is oxygen and M is selected from Ba, Sr, PB, Ca, Zn, Cu, Mg, and mixtures thereof. For example, the inorganic binder can be or comprise a glass frit comprising 10-90 wt % PbO, 0-20 wt % Al₂O₃, 0-40 wt % SiO₂, 0-15 wt % B₂O₃, 0-15 wt % ZnO, 0-85 wt % Bi₂O₃, 0-10 wt % Na₂O, 0-5 wt % Li₂O, 0-45 wt %, P₂O₅, 0-20 wt % NaF, and 0-10 wt % CdO. In another example, the inorganic binder can be a glass frit comprising: 0-15 wt % PbO, 0-5 wt % Al₂O₃, 0-20 wt % SiO₂, 0-15 wt % B₂O₃, 0-15 wt % ZnO, 65-85 wt % Bi₂O₃, 0-10 wt % Na₂O, 0-5 wt % Li₂O, 0-29 wt % P₂O₅, 0-20 wt % NaF, and 0-10 wt % CdO. Glass frit can be ground to provide powder sized particles (e.g., 2-6 microns) in a ball mill.

A wide variety of liquids can be used in the liquid medium provided that it acts as a carrier or vehicle for the molecular sieve and inorganic binder particles. The liquid medium can comprise water, organic solvents, low molecular weight polymers, and mixtures thereof. Examples of useful solvents, include but are not limited to, ethyl acetate and terpenes such as alpha- or beta-terpineol, kerosene, toluene, dibutylphthalate, butyl carbitol, butyl carbitol acetate, hexylene glycol, and other ethers, glycols, acetates, ether alcohols, esters, keytones, aromatic hydrocarbons, alcohols, alcohol esters, pyrrolidones, and mixtures thereof.

The liquid medium can contain additives suitable for conferring desired rheological and viscosity properties to the getter composition. A polymer and resins can be added to the liquid medium to aid in formation of a stable dispersion of the particles. For example, methyl cellulose, ethylhydroxyethyl cellulose, wood rosin, or mixtures of ethyl cellulose can be dissolved in a phenolic resin, a polymethacrylate of lower alcohols, or monobutyl ether of ethylene glycol monoacetate, and mixtures thereof. Surfactants and other processing aids may also added to the liquid medium.

As used herein, the term “solidifying” means drying sufficiently to stabilize the deposited getter composition, such as to prevent unacceptable spreading of the composition to undesired locations or damage caused by storing the surfaces containing solidified getter (e.g., by stacking). Solidifying can be accomplished as a separate act or included in a continuous act that results in the densifying of the getter composition.

As used herein, the term “surface” means the face of a solid object, a component in an organic electronic device, where the getter performance is needed. In one embodiment the surface to which the getter composition is adhered is an interior face of a lid or sealing apparatus that is assembled with at least one other component to form a housing or enclosure for an organic electronic device, or for a module that includes an organic electronic device. In another embodiment, the surface substantially planar. In another embodiment, the surface has a concave inner portion. The surface may be of any number of materials and may include metal, ceramic and glass and any variety of sizes and shapes. In one embodiment, the surface to which the getter in adhered is a glass lid or plate smaller than 20×20 mm and substantially planar.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The Getter Composition

The getter composition used in the present methods is a getter composition comprising particles of a getter and an inorganic binder in a liquid medium. The getter can be a molecular sieve which acts as an adsorbent. The inorganic binder, when fired, adheres the molecular sieve to the substrate.

The type and amount of liquid medium used is selected to be substantially completely volatilized upon heat treatment (i.e., at the solidification and densification) of the getter composition (or as in one embodiment, when a second composition consisting essentially of glass frit inorganic binder particles is applied to the surface in addition to at least one getter composition) so as to adhere the respective particles to the surface. The amount of the liquid medium is no greater than that which gives the desired type of getter composition desired and is such that the getter composition does not pour or flow easily, but rather needs some additional force or energy to be spread or to be applied to a surface. In one embodiment the getter composition has a liquid consistency in the range from a thick paste to a fluid ink. In another embodiment, the amount of the liquid medium is just sufficient to achieve a dispersion of the particles of inorganic binder and molecular sieve used, and will vary depending upon their choice. In one embodiment, the liquid medium is 10 wt. % of the getter composition. In one embodiment, the liquid composition is less than 30 wt. % of the getter composition. In another embodiment, the liquid medium is less than 50% of the getter composition.

In one embodiment of the getter composition, the weight ratio of molecular sieve to inorganic binder material is at least 1:1; in another embodiment the weight ratio of molecular sieve to inorganic binder material is at least 3:1; in another embodiment the weight ratio of molecular sieve to inorganic binder material is at least 6:1. The upper limit on the weight ratio of molecular sieve to inorganic binder is determined only by the amount of inorganic binder necessary to achieve good adhesion of the molecular sieve to the substrate.

Certain clays and glass frits are inherently water absorbing, as is known in the art. Therefore, when such binders are used in the getter compositions, the amount of molecular sieve to be added to the getter composition may be slightly less than would otherwise be needed to provide adequate capacity to adsorb the moisture and contaminant gas in any given situation (e.g., when the getter is incorporated into the enclosure and the enclosure is sealed shut). The water uptake or gas uptake capacity of the molecular sieve is a known property and is substantially unimpaired by the inorganic binder, which does not encase the molecular sieve particles completely, but allows the pores to remain substantially open. The volume of the interior of the device and the amount of water and/or gas in the air in the enclosure can be readily determined. Taking these factors into account an adequate weight of getter materials can be determined and incorporated into the getter composition.

The proportion of liquid medium in the getter composition controls the thickness of the getter composition applied as well as the mode of application. A dispersion having the consistency of a thick paste results in formation of a thicker getter layer (such dispersions are subject to shear-thinning and hence becomes thinner as the dispersion is worked on the surface). A watery composition, on the other hand, results in formation of a thinner film of solid getter when solidified.

In one embodiment, the getter composition comprises at least particles of synthetic zeolite, natural zeolite and clay in aqueous medium. In another embodiment, the getter composition comprising particles of natural or synthetic zeolite and powdered glass frit in an organic liquid medium, as disclosed herein, but is substantially water-free.

Applying the Getter Composition to the Surface

The consistency of the dispersion is conveniently selected to accommodate the method of applying the getter composition to a surface and the area and thickness of getter material desired for its final use. The solid particles in the getter composition are preferably mixed with the liquid medium by mechanical mixing to form a composition, having suitable consistency and rheology for application using any technique for applying a getter composition to a solid surface, including those well known in the art, such as by printing, such as silk screen printing or ink-jet printing, or coating by spraying, brushing, extruding, dispensing, syringe dispensing, stenciling, hand probe, doctor blading, and spin-coating. In one embodiment, the goal in selecting the proportions of the liquid medium and particles of getter and inorganic binder in the getter composition is to barely use enough of the liquid to form the desired type of getter composition and/or thickness of the resulting getter layer. For example, printing techniques may be used to achieve a getter composition thickness of no more than 10 microns. The getter composition used in the present method can also be applied to a surface in such a manner as to create a layer of getter having a shape or outline, pattern, and thickness, which will depend on design of the organic electronic device to be protected. Once applied to the surface, the getter composition is heat treated in a one- or multiple-step process involving solidification of the liquid to form a solid layer and densification of the solid layer by heating to obtain the solid layer adhered to the surface and to activate the getter.

In one embodiment, when the organic electronic device is an OLED, and the surface is the interior surface of the OLED lid, the getter composition is spread or otherwise coated onto the surface of the lid, usually a planar surface. One or more additional layers of the same or different getter composition can also be applied and/or a single layer can be applied in a pattern. In one embodiment, the OLED is a passive matrix device built on a glass substrate and the thickness of the getter composition used is no thicker than in the sub-micron range, in another embodiment the getter composition is thicker, for example in the tens of microns range. In other OLED devices, the thickness may vary depending on the size and the materials from which the OLED device is made.

In one embodiment, the getter composition is applied so as to maximize the surface area. This can be accomplished by applying the getter composition to substantially all of the surface available.

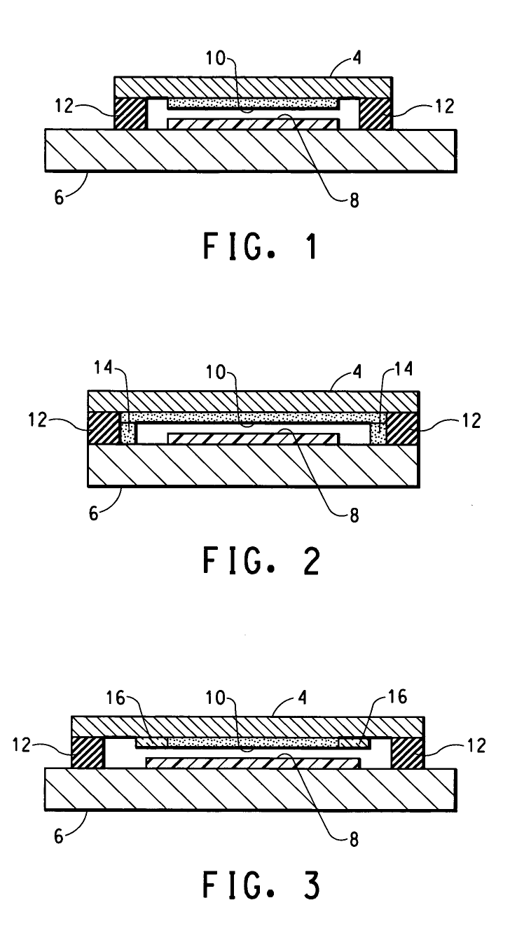

One embodiment of an electronic device with a getter prepared according to the methods described herein is shown in FIG. 1. Lid 4, which has a layer of getter 10 is adhered by means of a bead of epoxy 12 to substrate 6, which has active layers 8. In an OLED the active layers comprise an anode, a cathode and a light-emitting layer positioned therebetween.

In one embodiment, one or more additional layers of the same or a different getter composition, can be applied to the surface, either before or after densification of the first layer. For example, a second layer of the same getter composition can be applied to overlap at least a part of the first coating. For example, in FIG. 2, a planar lid 4 has a first getter layer 10 and a second getter layer 14. The second layer of the getter composition applied to make the first layer can be applied over the periphery of the first layer to build up a spacer ledge that holds the first getter layer and the device lid 4 spaced apart from the active layers 8 of the organic electronic device. A bead of epoxy 12 can be placed around the exterior of the ledge (as shown) or the on the surface just inside of the ledge to seal the lid to the substrate of the device. This embodiment provides the additional advantage that the ledge of getter material blocks transmission of contaminant gases through the bead of epoxy into the sealed device. If the epoxy bead is placed exterior to the ledge, the getter ledge also blocks transmission of outgases from the epoxy bead into the device.

In another embodiment, shown in FIG. 3, a planar lid 4 has a first getter layer 10 and a glassy frame 16, and is positioned over the active layers 8 on substrate 6. In this embodiment, one or more optional layers of a second composition is applied to the surface that is exterior to the periphery of the getter layer (rather than overlapping on the getter layer). In this embodiment, the second getter composition can comprise particles of glass frit (e.g., glass frit powder) in organic liquid medium, as disclosed herein, but does not contain molecular sieve. When densified, the layer(s) of the second getter composition form a glassy frame around the getter layer so as to contain the getter material in place during the densification procedure. This “frame” is particularly useful when the getter composition has properties that allow the components to become “runny” during densification, for the glass frit will become molten enough to adhere to the surface at a lower temperature than is required to densify the getter layer.

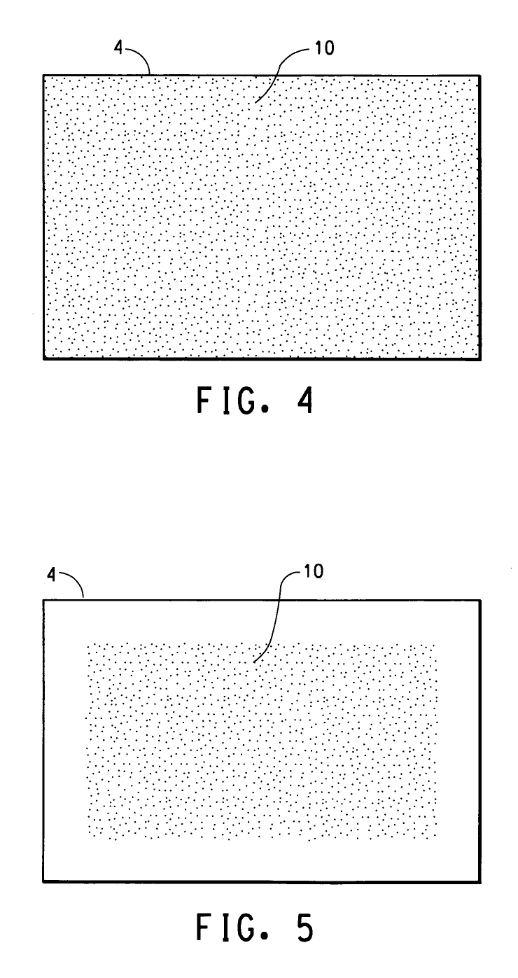

Some non-limiting examples of different patterns of getter composition and glass frit composition on lid 6 are shown in FIGS. 4-9. In FIG. 4 there is a uniform layer 10 of getter composition. Densification, discussed below, can be accomplished separatly from the drying/solidifcation step.

In FIG. 5, there is a uniform layer of getter composition 10 and a patterned layer of glass frit composition 16.

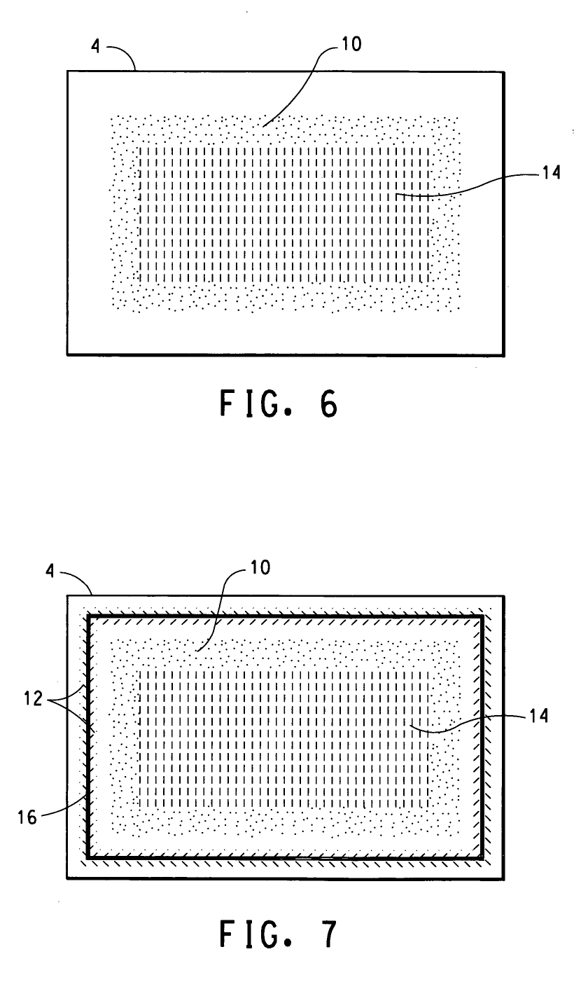

In FIG. 6, there is a first patterned layer of getter composition 10, and a second patterned layer of getter composition 14. The second patterned layer partially overlaps the first pattern, and may be of the same or different composition. In one embodiment (not shown) there are more than two patterns of getter composition, which can, but need not overlap.

In FIG. 7, there is a first patterned layer of getter composition 10 and a spaced apart patterned layer of glass frit composition 16. Optional adhesive layer 12 can be applied after densification as one means to secure the lid to the electronic device.

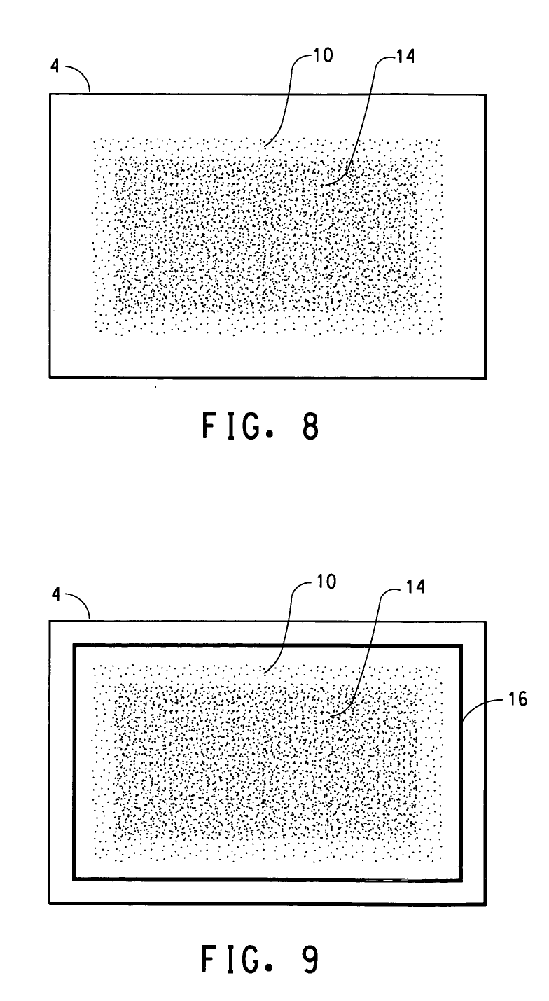

In FIG. 8, there is a first patterned layer of getter composition 10, and a spaced-apart second patterned layer of getter composition 14. The getter compositions can be the same or different.

In FIG. 9, there is a first overall layer of getter composition 10, a second patterned layer of getter composition 14, and a patterned layer of glass frit composition 16. The getter compositions can be the same or different.

Heat Treatment of the Getter

The getter composition (and any optional layers of getter composition) are heat treated directly on the surface to dry the composition as well as to adhere the getter to the surface and activate the molecular sieve in the getter. Heat treatment may take place in one continuous step (varying process conditions as needed during the continuous process) or in two or more steps, as manufacturing convenience dictates.

The heat-treatment step(s) are similar whether the getter composition comprises water or organic medium as the liquid, although the exact times and temperatures selected may vary. In the first step (or portion of the continuous process), the getter composition is solidified, at least sufficiently to prevent running or deformation of the getter layer. For example, the coated surface can be dried at room temperature or heated to remove the low-boiling materials by heating to a temperature of less than about 100° C. The solidifying step may require from about 1 hour to about 3 hours at this temperature. There is no need to control the moisture or gas environment during the solidifying step of the heat treatment. The surface bearing a solidified layer of getter can be conveniently stored at atmospheric conditions until its use is desired. For example, a lid for a device enclosure bearing a solidified coating of getter can be prepared independently of the manufacture of the organic electronic device and stored until such time as it is needed. Then the lid can be heat treated a densification conditions immediately prior to enclosing the device into an hermetically sealed atmosphere.

Thus, the densifying step can optionally be a separate second step in heat treatment of the getter. In densification, the inorganic binder becomes molten to promote adherence of the getter to the surface and zeolite is fired or calcined while any remaining volatiles are driven off i.e., water or organic liquid medium). For densification, a the getter materials can be heated to a temperature of at least about 400° C., such as about 450 C to about 550° C. or 650° C. To prevent readsorption of volatiles (and de-activation of the zeolite), the densifying step can be conducted in a controlled atmosphere void of moisture and other gases, such as under vacuum. In this case, the densifying step is usually performed immediately prior to sealing the device into the hermetic enclosure unless the densified getter is stored in an atmosphere void of moisture and/or other gases. Alternatively, solidification and densification can be performed as a single continuous process or step by slowly raising the temperature to densifying temperature. In this alternative embodiment of heat treating, the getter materials must be held at densifying conditions as described above (e.g. in an environment void of contaminant gases) for a period of time sufficient to ensure that the binder flows into voids in the substrate to provide adhesion and all volatiles have been driven from the zeolite to provide full gettering capability for the zeolite in the getter. Alternatively still, densifcation (whether in one ore more steps) under atmospheric conditions and the molecular sieve in the getter can be activated separately by reheating at any time (usually requiring a temperature of about 200° C.) in a moisture- and contaminant gas-free environment, such as under nitrogen gas, just prior to assembly of the device into an enclosure.

When densified, the present activated getter is a porous solid self-adhered to the surface without the need for attachment by other means, such as by adhesive. The particles of the molecular sieve contained in the getter provide a controlled pore structure into which water and/or molecules can travel and undergo physical adsorption so as to be trapped and not released into the environment inside the enclosure.

Thus, by using the present method of adhering a getter material to a solid surface, the getter can be “fired in place” on any surface that can withstand the heat treatment process, such as on the interior surface of a enclosure lid before the enclosure is assembled. The enclosure can then be assembled (in an environment devoid of contaminant gases) to incorporate the surface while encapsulating a moisture- and/or gas-sensitive organic electronic device to create a hermetic environment for the device or for a module comprising two or more such devices.

In one embodiment, the lid having the densified and activated getter material thereon is sealed to an electronic device without exposure to air and no exposure, or only minimal exposure to low water environments such as dry boxes. The getter compositions described herein are sensitive enough to trap moisture even in glove box environments having only ppm levels of water. In one embodiment, the lid having the activated getter material is sealed to the electronic device immediately after activation. In one embodiment, the time between completion of activation and sealing of the lid to the device, is less than 120 minutes. In one embodiment, the time is less than 60 minutes.

In one embodiment, the lid having the densified and activated getter material thereon is stored in full vacuum of 10⁻⁴ torr or less. The lid can then be sealed to the electronic device when under full vaccuum. Alternatively, the lid can be sealed to the electronic device in a low water environment within a short time period after removal from full vacuum. In one embodiment, after being removed from full vacuum, the lid is exposed to the low water environment for less than 120 minutes. In one embodiment, the lid is exposed to the low water environment for less than 60 minutes.

In one embodiment, the lid having the densified and activated getter material thereon is at an elevated temperature when it is sealed to an electronic device. This can be accomplished by using the lid after densification and before it has completely cooled. Alternatively, the lid can be completely cooled and reheated prior to sealing to the device. In one embodiment, the lid is at a temperature greater than 50° C. In one embodiment, the lid is at a temperature greater than 100° C. In most embodiments the temperature will not exceed 200° C.

In one embodiment, the lid having the densified and activated getter material thereon is sealed to an electronic device without exposure to air and only minimal exposure to low water environments such as dry boxes, and further is at an elevated temperature.

For convenience, the present method of preparing a packaged organic electronic device comprising a layer of getter adhered to the interior surface of a hermetically sealed enclosure is illustrated with reference to a PLED. However the invention is conceived to encompass any type of moisture- and/or gas-sensitive device, including without limitation, any type of electronic organic device. It is also contemplated within the scope of the invention that a module packaged according to the present methods may combine two or more such devices within a single hermetically sealed enclosure.

The present methods for adhering a getter to a substrate are completely independent of manufacture of the device. Since heat treatment of the getter is independent of the device, no special consideration of the sensitivities of the device need be taken in manufacture of the getter and no special consideration of the sensitivities of the getter (i.e., deactivation) need be taken in manufacture of the device until the getter is encapsulated along with the device into the enclosure.

The remarkable improvement in stability and lifetime of the gas-sensitive organic electronic device, when hermetically sealed in a enclosure along with the present solid getter, as described herein, is illustrated in the Examples. In particular, encapsulation with the absorbing zeolite material as desiccant significantly outperforms barium-oxide as desiccant, which removes moisture by chemical absorption.

The invention will be further described in the following examples, which do not limit the scope of the invention described in the claims.

### EXAMPLES

The following examples illustrate manufacture and use of the present methods for adhering getters to a substrate and compare getter performance with prior art examples of getters.

### Example 1

This example illustrates the present invention applying the getter composition. The getter composition was a liquid dispersion of particles of a zeolite-based molecular sieve and glass frit in an organic liquid medium. The dispersion comprised the following ingredients by wt % of total dispersion:

| Inorganic components | |
|---|---|
| Zeolite-based molecular sieve (13x-typed powder) | 54.1 |
| Glass frit | 5.4 |
| Organic components | |
| surfactant | 1.1 |
| ethylcellulose resin | 1.0 |
| Texanol solvent (ester alcohol) | 38.4% |

The composition of the glass frit in wt % (dry) was as follows:

| SiO₂ | Al₂O₃ | B₂O₃ | CaO | ZnO | Bi₂O₃ |
|---|---|---|---|---|---|
| 7.11 | 2.13 | 8.38 | 0.53 | 12.03 | 69.82 |

### Example 2

This example illustrates making and performance of method of applying the getter composition of the present invention. A slurry of 0.75 tablets of unfired DESIWAFER 300/20 zeolite-clay material in 1 ml of water was dispersed in water to make a 200 ml dispersion. The dispersion was applied to a cavity on a glass lid plate in 0.5 ml aliquots by hand using a syringe. The getter was solidified by placing in a vacuum oven for 1 hour at 70° C. to remove substantially all of the water. After solidification, the getter layers were then activated and densified by heating the glass lid plates for 2 hours at 500° C. In an environment having less than 10 ppm H₂O and O₂, the plates with self-attached getter layers were then each assembled into an enclosure holding a PLED device. Control polymer light emitting diode devices (PLEDS) were assembled into an enclosure under the same conditions, except that the getter layer was replaced by a fired DESIWAFER tablet (Sud-Chemie) attached to a plate by dispensing an adhesive, placing the tablet on the adhesive and UV curing the adhesive to secure the tablet to the lid cavity. All encapsulated PLEDs, including controls, were then placed in a storage test environment of 70° C. and 95% RH overnight and tested for moisture degradation by measuring pixel shrinkage. The pixel shrinkage for the devices protected by the getter layer made by the present methods was 8-10% vs. 5-7% for the controls using the fired DESIWAFER tablets.

Although the invention has been described with reference to the presently preferred embodiment, it should be understood that various modifications could be made without departing from the spirit of the invention. Accordingly, the invention is limited only by the following claims.

1. A method for adhering a getter material to a surface, said method comprising the steps of:
(a) applying to at least a portion of a surface at least one getter composition comprising:
(i) particles of at least one getter;
(ii) particles of at least one inorganic binder; and
(iii) a liquid medium, and
(b) densifying the getter composition in a environment substantially free of contaminants so as to activate the getter material and to cause it to adhere to the surface.

2. The method of claim 1, wherein the getter comprises a molecular sieve.

3. The method of claim 2, wherein the molecular sieve comprises a zeolite.

4. The method of claim 1, wherein the inorganic binder comprises at least one material selected from glass frits and clay particle materials.

5. The method of claim 1, wherein the inorganic binder comprises a glass frit comprising Al₂O₃, SiO₂, B₂O₃, PbO, K₂O, Bi₂O₃, Na₂O, Li₂O, P₂O₅, NaF, CdO, and MO where O is oxygen and M is selected from Ba, Sr, PB, Ca, Zn, Cu, Mg, and mixtures thereof; and the molecular sieve particles comprise at least one synthetic zeolite or natural zeolite.

6. The method of claim 5, wherein the liquid medium comprises at least water or an organic solvent.

7. The method of claim 1, further comprising solidifying getter composition on the surface prior to the densifiying in steb (b).

8. The method of claim 1, wherein the at least a portion of one getter material is applied to the surface using blading, screen print, knife spreading, extruding or combinations of such applications methods.

9. The method of claim 1, wherein the surface to which the getter composition is applied is substantially flat.

10. The method of claim 1, wherein the inorganic binder further comprises magnesium aluminosilicate.

11. The method of claim 1, wherein the getter composition has a consistency of paste and can be applied using a screen printing technique.

12. The method of claim 7, wherein solidifying step is achieved by heating the getter composition on the surface to a temperature of less than 100° C.

13. The method of claim 1, wherein the densifying comprises heating the getter composition on the surface to a temperature of at least about 400° C.

14. The method of claim 1, wherein the densifying comprises heating the getter composition on the surface to a temperature of from about 400° C. to about 650° C.

15. The method of claim 6, wherein the solidifying and the densifying are accomplished without a pause in the method.

16. The method of claim 1, further comprising:
applying to another portion of the surface at least a second getter composition prior to densification step b.

17. The method of claim 1, wherein a glass frit composition consisting essential of glass frits and an organic solvent is applied to a portion of the surface outside of the portion to which one or more getter compositions are applied.

18. The method of claim 17, wherein the glass frit composition is applied to a portion of the surface exterior to the perimeter of the solidified getter composition formed in (b) to form a continuous glassy ledge; and the solidified getter layer and the continuous glassy ledge are both densified on the surface so as to adhere the glass frit composition and the getter composition to the surface, said glass frit forming a glassy frame during densification to contain the getter layer.

19. The method of claim 17, wherein the glass frit composition is applied over at least of portion of at least one of said getter compositions applied in step (a) prior to the densifying in (b).

20. An electronic device comprising at least one surface to which a getter composition has been adhered in accordance with claim 1.

21. The device of claim 20, wherein device is an organic electronic device.

22. A structure useful to seal an electronic device, said structure comprising: (a) a getter material adhered, in accordance to claim 1, to at least a portion of at least one surface of said structure, wherein such portion of said surface will be an interior surface when the structure is used in an electronic device.

23. A method for sealing an electronic device on a substrate with a sealing structure, said method comprising:
(a) applying to at least a portion of a surface of a lid at least one getter composition comprising:
(i) particles of at least one getter;
(ii) particles of at least one inorganic binder; and
(iii) a liquid medium, and
(b) densifying the getter composition in a environment substantially free of contaminants so as to activate the getter material and to cause it to adhere to the surface, to form the activated sealing structure;
(c) adhering the activated sealing structure to the substrate so as to enclose the electronic device; with the proviso that at least one of the following conditions is met:
(1) the activated sealing structure is at a temperature greater than 50° C. in step (c);
(2) the activated sealing structure is kept under a vacuum of less than 10⁻⁴ torr between step (b) and step (c);
(3) the time elapsed between step (b) and step (c) is less than 120 minutes.

24. The method of claim 23, wherein the activated sealing structure is at a temperature greater than 100° C. in step (c).

25. The method of claim 23, wherein the activated sealing structure is kept under a vacuum of less than 10⁻⁴ torr between step (b) and step (c) and the activated sealing structure is at a temperature greater than 50° C. in step (c).
